(19) United States
(12) Patent Application Publication
(10) Pub. No.: US 2025/0378714 A1
(43) Pub. Date: Dec. 11, 2025

(54) SYSTEMS AND METHODS TO FACILITATE VEHICLE INSPECTION

(71) Applicant: Ford Global Technologies, LLC, Dearborn, MI (US)

(72) Inventors: Andrew Brown, Royal Oak, MI (US); Keith Weston, Canton, MI (US); Anthony Maraldo, Southgate, MI (US); Matthew Flis, Northville, MI (US)

(73) Assignee: Ford Global Technologies, LLC, Dearborn, MI (US)

(21) Appl. No.: 18/737,003

(22) Filed: Jun. 7, 2024

(51) Int. Cl. G07C 5/00; G07C 5/08

(52) U.S. Cl. CPC G07C 5/006; G07C 5/008; G07C 5/0825

(57) ABSTRACT

A vehicle including a plurality of vehicle components to be inspected and a processor is disclosed. The processor may be configured to output notifications to inspect the plurality of vehicle components sequentially, responsive to obtaining a first request from a user to perform a vehicle inspection. The processor may further obtain responses sequentially from the user associated with states of the vehicle components, responsive to outputting the notifications. The processor may further obtain a second request from the user to shift the vehicle out of a park mode, and determine that the vehicle inspection is not yet complete responsive to obtaining the second request. The processor may disable the vehicle from shifting out of the park mode responsive to determining that the vehicle inspection is not yet complete.

### FIELD

The present disclosure relates to systems and methods to facilitate inspection of vehicles.

### BACKGROUND

In some instances, operators of commercial vehicles may inspect their vehicles before commencing on trips. Vehicle inspection can be a tedious and time-consuming task.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to facilitate vehicle inspection in accordance with the present disclosure.

FIG. 3 depicts a view of a user sitting in a vehicle in accordance with the present disclosure.

FIG. 4 depicts a view of a user located in proximity to a vehicle in accordance with the present disclosure.

FIG. 5 depicts a flow diagram of a method to facilitate vehicle inspection in accordance with the present disclosure.

### DETAILED DESCRIPTION

### Overview

The present disclosure describes a vehicle that may assist a vehicle operator/user to perform vehicle inspection before commencing a vehicle trip. The vehicle may be a commercial vehicle and may assist the user to thoroughly and conveniently inspect a plurality of interior and exterior vehicle components that are required to be inspected before the user commences a vehicle trip. In some aspects, the user may transmit, via a user device or a vehicle Human-Machine Interface (HMI), a vehicle inspection request to the vehicle when the user desires to perform the vehicle inspection. Responsive to obtaining the vehicle inspection request, the vehicle may activate a vehicle inspection mode. In some aspects, the vehicle may not allow/enable the vehicle to shift out of a park mode or move till the vehicle is in the inspection mode.

Further, responsive to obtaining the vehicle inspection request, the vehicle may determine/check whether the user is located inside the vehicle or outside the vehicle, based on inputs obtained from a vehicle sensor unit. The vehicle may assist the user to perform an interior vehicle inspection when the user may be located inside the vehicle and may assist the user to perform an exterior vehicle inspection when the user may be located outside the vehicle.

When the user may be located inside the vehicle, the vehicle may begin to sequentially output notifications requesting the user to inspect the plurality of interior vehicle components in a preset order. The vehicle may further sequentially activate/actuate one or more interior vehicle components and/or output information associated with the state/condition of the interior vehicle components, to facilitate the user to optimally inspect the interior vehicle components. The user may provide responses associated with the state/condition of each interior vehicle component to the vehicle, indicating whether the user considers the vehicle component state to be acceptable or unacceptable. In some aspects, the vehicle may transmit an error notification to a fleet manager/operator device when a response obtained from the user indicates an unacceptable vehicle component state.

The vehicle may consider the vehicle's interior inspection to be complete when the vehicle obtains responses associated with the states of all interior vehicle components from the user, and no response indicates an unacceptable interior vehicle component. After the vehicle's interior inspection is complete, the vehicle may output a notification requesting the user to move out of the vehicle and perform and complete the vehicle's exterior inspection. The vehicle may assist the user in performing the vehicle's exterior inspection in the same manner as the vehicle assists the user in performing the vehicle's interior inspection.

In some aspects, the user may first perform and complete the vehicle's interior inspection and then perform and complete the vehicle's exterior inspection. In other aspects, the user may first perform and complete the vehicle's exterior inspection and then perform and complete the vehicle's interior inspection. The vehicle may consider the inspection of the entire vehicle to be complete when both the vehicle's interior inspection and the vehicle's exterior inspection are complete. Responsive to the entire vehicle inspection to be complete, the vehicle may deactivate the inspection mode.

Furthermore, if the user transmits a vehicle movement request to move the vehicle or shift the vehicle out of the park mode when the vehicle inspection is not yet complete (i.e., when the vehicle is still in the inspection mode), the vehicle may disable the vehicle from shifting out of the park mode. In this case, the vehicle may output a notification requesting the user to first complete the vehicle inspection and then drive/move the vehicle. In this manner, the vehicle encourages/facilitates the user to complete the vehicle inspection process before every new vehicle trip, thereby enhancing vehicle performance.

The present disclosure discloses a vehicle that facilitates a user to conveniently and thoroughly perform vehicle inspection before commencing a vehicle trip. The vehicle may not enable the user to drive the vehicle till the vehicle inspection is complete, thereby ensuring that the user does not miss on performing the vehicle inspection or does not perform an incomplete inspection. The vehicle further transmits error notifications to the fleet operator device whenever a vehicle component is flagged as unacceptable by the user/driver, thereby enabling the fleet manager/operator to timely replace/repair faulty vehicle component(s).

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

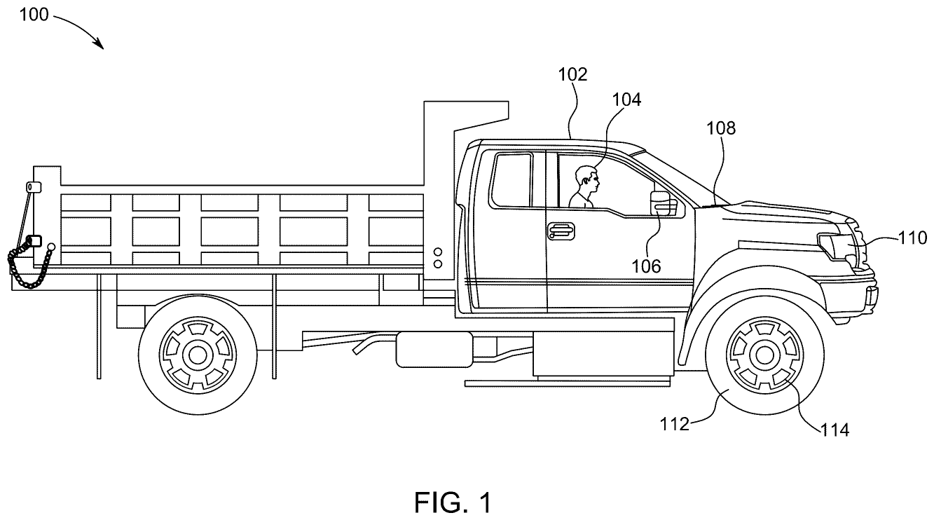

FIG. 1 depicts an environment 100 in which techniques and structures for providing the systems and methods disclosed herein may be implemented. The environment 100 may include a vehicle 102 that may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain such as a gasoline engine, one or more electrically-actuated motor(s), a hybrid system, etc.

In an exemplary aspect, the vehicle 102 may be a commercial vehicle that may be operated or required to be driven by a commercial vehicle driver/user 104. In the aspect depicted in FIG. 1, the user 104 is shown to be located inside the vehicle 102; however, the present disclosure is not limited to such an aspect. In an alternative aspect, the user 104 may be located outside the vehicle 102 (e.g., standing in proximity to a vehicle exterior portion).

In some aspects, the user 104 may be required to perform vehicle inspection before commencing a vehicle trip. The vehicle inspection, as described here in the present disclosure, may mean inspection of a plurality of interior vehicle components and/or a plurality of exterior vehicle components (collectively referred to as a plurality of vehicle components) that may require inspection before the vehicle trip and confirmation whether each vehicle component is operating optimally or may require repair/replacement. In some aspects, the “interior vehicle components,” as described here in the present disclosure, may mean those vehicle components that may be inspected by the user 104 while sitting inside the vehicle 102 and may not necessarily mean that the vehicle components are physically located inside the vehicle 102 (or in an interior vehicle portion). Examples of interior vehicle components include, but are not limited to, horn, heater/air conditioning unit, rear view mirror, side rear view mirrors 106, wipers 108, wiper fluid, fuel gauge, sitting area straps, steering wheel, and/or the like.

In a similar manner, the “exterior vehicle components”, as described here in the present disclosure, may mean those vehicle components that may be inspected by the user 104 while being located in proximity to the vehicle exterior portion or outside the vehicle 102 and may not necessarily mean that the vehicle components are physically located exterior to the vehicle 102 (or on an exterior vehicle portion). Examples of exterior vehicle components include, but are not limited to, exterior lights 110, sound exciters, wheels 112, rims 114, external façade, and/or the like.

The examples of interior and exterior vehicle components described above should not be construed as limiting, and the vehicle 102 may include more interior and exterior vehicle components that may require inspection before a vehicle trip. Further, some interior vehicle components described above may also be or alternatively be part of exterior vehicle components. Similarly, some exterior vehicle components described above may also be or alternatively be part of interior vehicle components.

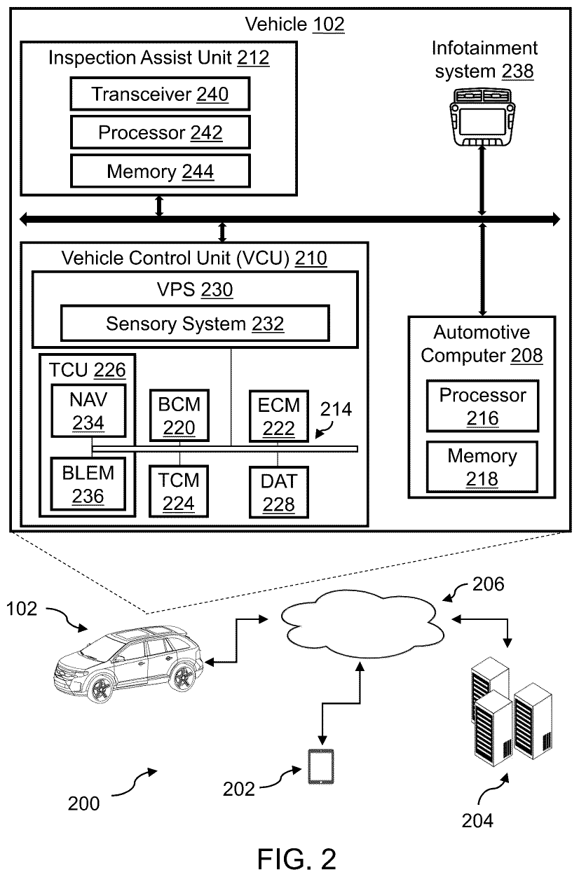

In some aspects, the vehicle 102 may be configured to facilitate the user 104 to inspect the vehicle 102 thoroughly and may not enable the user 104 to drive the vehicle 102 (or shift the vehicle 102 out of a park mode) till the vehicle inspection is complete. To perform vehicle inspection, the user 104 may first transmit a vehicle inspection request (or a “first request”) to the vehicle 102. In some aspects, the user 104 may transmit the vehicle inspection request to the vehicle 102 via a user device (shown as user device 202 in FIG. 2), a vehicle Human-Machine Interface (HMI, shown as infotainment system 238 in FIG. 2), a voice command, and/or the like. Responsive to obtaining the vehicle inspection request from the user 104, the vehicle 102 may determine whether the user 104 may be sitting or located inside the vehicle 102 or in the vehicle interior portion (as shown in FIG. 1), or the user 104 may be located outside the vehicle 102 in proximity to the vehicle exterior portion based on inputs obtained from a vehicle sensor unit or a vehicle sensory system (shown as vehicle sensory system 232 in FIG. 2).

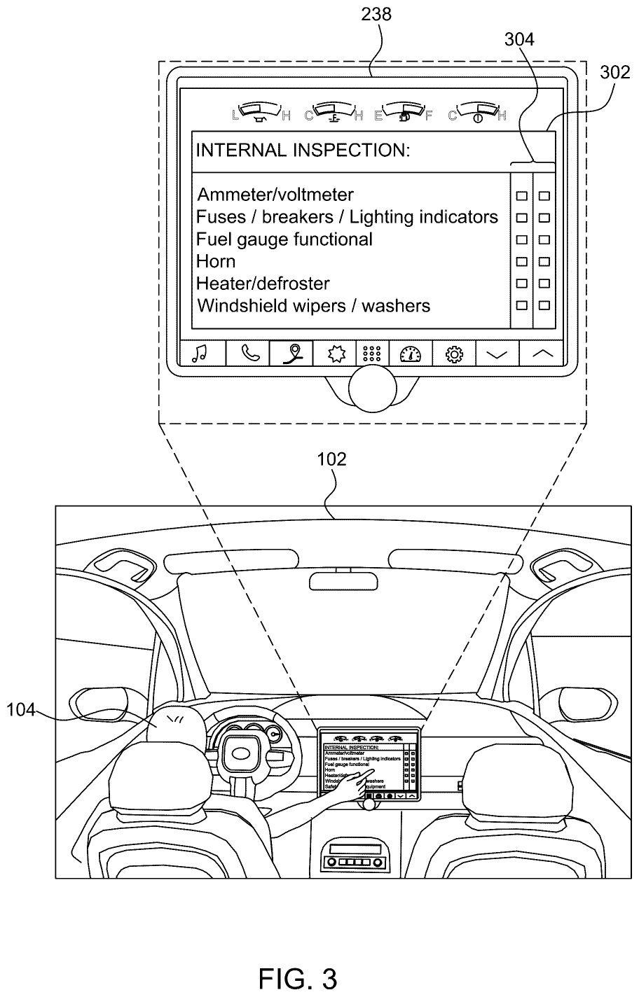

The vehicle 102 may output a first checklist (shown as a first checklist 302 in FIG. 3) associated with the plurality of interior vehicle components on the user device and/or the HMI, when the vehicle 102 determines that the user 104 may be sitting or located inside the vehicle 102. The first checklist may include identifiers or names of the plurality of interior vehicle components that should be inspected by the user 104 as part of the vehicle inspection process before a vehicle trip. The first checklist may also include provision or means for the user 104 to provide user inputs or responses associated with a state or an operation of each interior vehicle component. For example, the first checklist may include provision or means through which the user 104 may add a response for a particular vehicle component indicating whether the state/status/operating condition associated with the vehicle component is acceptable or unacceptable. In some aspects, a user response indicating an unacceptable state of a vehicle component may mean that the vehicle component requires repair or replacement, and the user 104 considers the vehicle component state/condition to be suboptimal.

Responsive to outputting the first checklist or in parallel to outputting the first checklist, the vehicle 102 may sequentially start to output notifications requesting the user 104 to inspect each interior vehicle component in a preset order and sequentially start to activate/actuate one or more interior vehicle components in the preset order and/or output information associated with states of one or more interior vehicle components (that may be obtained from the vehicle sensor unit) on the user device and/or the HMI. Responsive to viewing/hearing the notifications, the user 104 may view or visually inspect the state of each interior vehicle component as the vehicle component may be getting activated/actuated or its state information may be getting displayed on the user device and/or the HMI and may accordingly input responses in a sequential manner on the first checklist (via the user device/HMI) indicating whether the vehicle component state/condition is acceptable or unacceptable to the user 104. For example, the user 104 may view the windshield as the vehicle 102 automatically sprays the windshield wiper fluid and the wipers 108 clean the windshield and may add a response on the first checklist indicating whether the wiper condition/state is acceptable or unacceptable to the user 104. As another example, the user 104 may view the functional status of the fuel gauge, breaker/fuse status, oil level, etc., as the status/state information may be getting displayed on the user device or the HMI and may add responses to the first checklist indicating whether the conditions/states of the fuel gauge, breaker/fuse, etc. are acceptable or unacceptable to the user 104. As yet another example, the user 104 may manually check condition/status of one or more interior vehicle components, e.g., steering wheel, sitting area straps, etc., and may add responses to the first checklist indicating whether the conditions/states of these components are acceptable or unacceptable to the user 104.

The vehicle 102 may start to obtain the responses sequentially as the user 104 inputs them on the first checklist via the user device/HMI and may determine/check whether any response indicates an unacceptable vehicle component state/condition for the user 104. Responsive to identifying a response indicating an unacceptable vehicle component state/condition (e.g., a response that indicates that the user 104 considers the wiper state as unacceptable), the vehicle 102 may either automatically transmit an error notification to a server or a computing device associated with a fleet operator and/or a vehicle maintenance firm, or may provide/output a link on the user device/HMI through which the user 104 may transmit the error notification to the server or the computing device. The error notification may include an identifier associated with the vehicle component (e.g., the wipers 108) that the user 104 considers to be in an unacceptable condition. The fleet operator and/or the vehicle maintenance firm may view the error notification and may accordingly repair or replace (or plan to repair/replace) the vehicle component that is in the unacceptable condition.

In this manner, the vehicle 102 facilitates the user 104 to inspect each interior vehicle component sequentially in a preset order and provide responses indicating whether the vehicle component condition/state is acceptable or unacceptable to the user 104. Since the vehicle 102 automatically outputs notifications in a sequential manner requesting the user 104 to inspect each interior vehicle component, the probability of user 104 missing out on inspecting any interior vehicle component is substantially reduced. Further, the notifications and the automatic actuation and/or display of state information of each interior vehicle component assist the user 104 in optimally inspecting the vehicle 102, even if one or more vehicle features/components may not be known to the user 104 (e.g., if the user 104 does not regularly operate a type of vehicle like the vehicle 102). In this manner, the user 104 is not required to “remember” or know beforehand functioning or location of each interior vehicle component that is required to be inspected in the vehicle 102, as the vehicle 102 automatically notifies (e.g., via the notifications described above) the user 104 to check each interior vehicle component sequentially in a preset order. In additional aspects, the vehicle 102 may also output vehicle component information on the user device and/or the HMI as the vehicle 102 outputs the notifications described above, which assists the user 104 in optimally inspecting each vehicle component. Such vehicle component information may include, for example, information associated with the vehicle component location in the vehicle 102, training or tutorial material instructing the user 104 how to inspect the vehicle component, detailed description associated with the vehicle component functioning, vehicle component photographs, and/or the like. In this manner, the vehicle 102 facilitates the user 104 to conveniently and thoroughly inspect the plurality of interior vehicle components.

In a similar manner as described above, the vehicle 102 may facilitate the user 104 to inspect the plurality of exterior vehicle components, when the vehicle 102 determines that the user 104 may be located outside the vehicle 102 in proximity to the vehicle exterior portion. The details associated with inspection of the exterior vehicle components are described below in conjunction with FIG. 2.

In some aspects, the vehicle 102 may consider the vehicle inspection process to be complete when the user 104 may have inspected and confirmed that all of the plurality of interior vehicle components and the plurality of exterior vehicle components are in acceptable condition. Stated another way, the vehicle 102 may consider the vehicle inspection process to be complete when the vehicle 102 obtains a response from the user 104 for each interior and exterior vehicle component, indicating that the user 104 considers the state/condition of each interior and exterior vehicle component as acceptable/optimal. In some aspects, the vehicle 102 may consider the vehicle inspection process to be incomplete if one or more responses associated with one or more interior and/or exterior vehicle components are not obtained by the vehicle 102 from the user 104, and/or one or more responses indicate that the user 104 considers states/conditions of one or more interior and/or exterior vehicle components as unacceptable. In the latter case, the vehicle 102 may not consider the inspection process to be complete till the “unacceptable” or suboptimal vehicle components are replaced or repaired (e.g., by the fleet manager).

In some aspects, when the user 104 desires to move or drive the vehicle 102, the user 104 may transmit a vehicle movement request (or a “second request”) to the vehicle 102 via the user device, the HMI and/or the vehicle transmission, to shift the vehicle 102 out of a park mode. Responsive to obtaining the vehicle movement request from the user 104, the vehicle 102 may first check whether the vehicle inspection process is complete or is yet to be completed. Stated another way, responsive to obtaining the vehicle movement request from the user 104, the vehicle 102 may determine whether responses associated with the state/condition/functioning for all the interior and exterior vehicle components are obtained from the user 104 and/or whether any response indicates a suboptimal or unacceptable vehicle component state/condition.

Responsive to determining that the vehicle inspection process is complete when the user 104 transmits the vehicle movement request, the vehicle 102 may shift out of the park mode, thus enabling the user 104 to move/drive the vehicle 102. On the other hand, responsive to determining that the vehicle inspection process is not yet complete when the user 104 transmits the vehicle movement request, the vehicle 102 may disable the vehicle 102 from shifting out of the park mode. In this case, the vehicle 102 may output a notification on the user device/HMI, requesting the user 104 to first complete the vehicle inspection and/or get the vehicle component in suboptimal/unacceptable condition repaired/replaced, before attempting to shift the vehicle 102 out of the park mode. In this manner, the vehicle 102 facilitates the user 104 to complete the vehicle inspection thoroughly and ensures that the vehicle 102 is not driven till the vehicle inspection process is complete. If required, the fleet operator/manager may override this disablement of vehicle movement by the vehicle 102, and may still enable the user 104 to use/drive the vehicle 102.

Further vehicle details are described below in conjunction with FIG. 2.

The vehicle 102 and/or the user 104 implement and/or perform operations, as described here in the present disclosure, in accordance with the owner manual and safety guidelines. In addition, any action taken by the user 104 based on the notifications/recommendations provided by the vehicle 102 should comply with all the rules specific to the location and operation of the vehicle 102 (e.g., Federal, state, country, city, etc.). The notifications/recommendations, as provided by the vehicle 102, should be treated as suggestions and only followed according to any rules specific to the location and operation of the vehicle 102.

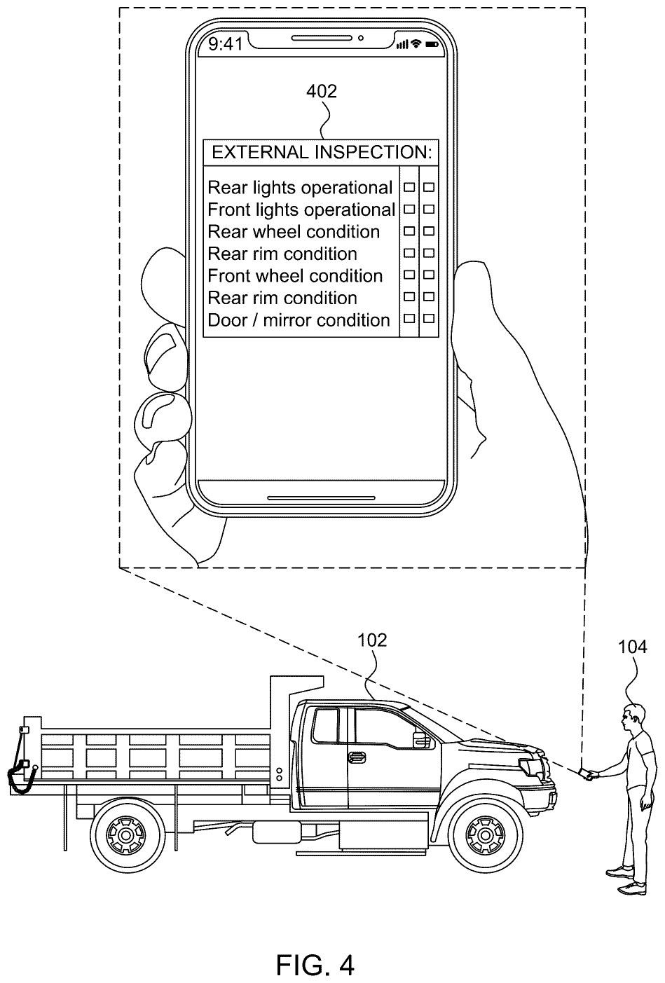

FIG. 2 depicts a block diagram of a system 200 to facilitate vehicle inspection in accordance with the present disclosure. While describing FIG. 2, references will be made to FIGS. 3 and 4.

The system 200 may include the vehicle 102, a user device 202 and one or more servers 204 (or a server 204) communicatively coupled with each other via one or more networks 206. The user device 202 may be associated with the user 104 and may be, for example, a mobile phone, a computer, a laptop, a smartwatch, a tablet, or any other device with communication capabilities. The server 204 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet. In further aspects, the server 204 may be associated with a fleet manager/operator managing the vehicle operation. In other aspects, the server 204 may be associated with a vehicle maintenance firm that may repair or replace one or more faulty or suboptimal vehicle components associated with the vehicle 102. In yet another aspect, the server 204 may be configured to provide checklists required to inspect the plurality of interior and exterior vehicle components, training information, photographs, detailed description associated with each vehicle component, and/or the like to the vehicle 102, which may assist the user 104 to thoroughly inspect the vehicle 102. The server 204 may transmit the information described above to the vehicle 102 at a predefined frequency, or when the vehicle 102 transmits a request to the server 204 to obtain such information.

The network(s) 206 illustrates an example communication infrastructure in which the connected devices discussed in various embodiments of this disclosure may communicate. The network(s) 206 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 208, a Vehicle Control Unit (VCU) 210, and an inspection assist unit 212 (or unit 212). The VCU 210 may include a plurality of Electronic Control Units (ECUs) 214 in communication with the automotive computer 208.

In some aspects, the automotive computer 208 and/or the unit 212 may be installed anywhere in the vehicle 102, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing an inspection assist program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle 102 systems, connected servers (e.g., the server(s) 204), and other vehicles (not shown in FIG. 2) operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232 (or a “sensor unit”). The vehicle sensory system 232 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, ultrasonic sensors, temperature sensors, wheel sensors, ambient weather sensors, vehicle internal and external cameras, one or more rain sensors, capacitive moisture sensors, etc.

In some aspects, the vehicle sensory system 232 may be configured to detect a presence of the user 104 in the vehicle interior portion or in proximity to the vehicle exterior portion. In further aspects, the vehicle sensory system 232 may be configured to determine/capture information associated with states of one or more interior and exterior vehicle components. Examples of such information include, but are not limited to, an information associated with a change in state of a vehicle component over a predefined time duration (e.g., a change in oil level, air pressure levels, etc. since the last vehicle inspection, or over the past 15 days, 1 month, 3 months, etc.), vehicle component images (images of sitting area straps, grease on hubs, the wipers 108, sitting areas, etc.), and/or the like.

In some aspects, the VCU 210 may control vehicle operational aspects and implement one or more instruction sets received from the user device 202, the server 204, from one or more instruction sets stored in the memory 218, including instructions operational as part of the unit 212.

The TCU 226 may be configured and/or programmed to provide vehicle connectivity to wireless computing systems onboard and off board the vehicle 102 and may include a Navigation (NAV) receiver 234 for receiving and processing a GPS signal, a BLE Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a key fob, not shown), computers, and modules. The TCU 226 may be in communication with the ECUs 214 by way of a bus.

The ECUs 214 may control aspects of vehicle operation and communication using inputs from human drivers, inputs from an autonomous vehicle controller, the unit 212, and/or via wireless signal inputs received via the wireless connection(s) from other connected devices, such as the user device 202, the server(s) 204, among others.

The BCM 220 generally includes integration of sensors, vehicle performance indicators, and variable reactors associated with vehicle systems and may include processor-based power distribution circuitry that can control functions associated with the vehicle body such as lights, windows, security, camera(s), headlights, audio system(s), speakers, the wipers 108, door locks and access control, and various comfort controls. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI)). The infotainment system 238 may include a touchscreen interface portion and may include voice recognition features, biometric identification capabilities that can identify users based on facial recognition, voice recognition, fingerprint identification, or other biological identification means. In other aspects, the infotainment system 238 may be further configured to receive user instructions/inputs via the touchscreen interface portion, and/or display notifications/recommendations, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 102, may include a transceiver 240, a processor 242, and a computer-readable memory 244, which may be communicatively coupled with each other.

The transceiver 240 may be configured to receive information/inputs from one or more external devices or systems, e.g., the user device 202, the server(s) 204, and/or the like via the network 206. For example, the transceiver 240 may receive the checklists required to inspect the plurality of interior and exterior vehicle components, training information, photographs, detailed description associated with each vehicle component, and/or the like from the server(s) 204 via the network 206. Further, the transceiver 240 may transmit notifications (e.g., alert/alarm signals) to the external devices or systems. In addition, the transceiver 240 may be configured to receive information/inputs from vehicle 102 components such as the infotainment system 238, the vehicle sensory system 232, and/or the like. Further, the transceiver 240 may transmit notifications (e.g., alert/alarm/command signals) to the vehicle 102 components such as the infotainment system 238, the VCU 210, etc.

The processor 242 and the memory 244 may be the same as or similar to the processor 216 and the memory 218, respectively. In some aspects, the processor 242 may utilize the memory 244 to store programs in code and/or to store data for performing aspects in accordance with the disclosure. The memory 244 may be a non-transitory computer-readable medium or memory storing the inspection assist program code. In some aspects, the memory 244 may be configured to store the checklists required to inspect the plurality of interior and exterior vehicle components, training information, photographs, detailed description associated with each vehicle component, and/or the like (collectively referred to as “component information”), which the vehicle 102 obtains from the server(s) 204.

In operation, the user 104 may transmit the vehicle inspection request or the first request to the transceiver 240 via the user device 202, the infotainment system 238, a voice command, and/or the like, before commencing a vehicle trip. The transceiver 240 may transmit the first request to the processor 242. The processor 242 may obtain the first request and may activate a vehicle inspection mode responsive to obtaining the first request. In some aspects, the processor 242 may not enable the vehicle 102 to move or shift out of the park mode, till the vehicle 102 is in the vehicle inspection mode.

Responsive to activating the vehicle inspection mode, the processor 242 may obtain inputs from the vehicle sensory system 232 and determine whether the user 104 is located in the vehicle interior portion/sitting inside the vehicle 102 (as shown in FIGS. 1 and 3) or located outside the vehicle 102 in proximity to the vehicle exterior portion (as shown in FIG. 4) based on the obtained inputs. In some aspects, the processor 242 may output a first checklist 302 (by fetching it from the memory 244) on/via the user device 202, an interior vehicle speaker and/or the infotainment system 238 when the processor 242 determines that the user 104 may be located in the vehicle interior portion. As shown in FIG. 3, the first checklist 302 may include identifiers or names associated with the plurality of interior vehicle components that should be inspected by the user 104 as part of the vehicle inspection process. The example vehicle component names depicted in FIG. 3 as part of the first checklist 302 should not be construed as limiting, and the first checklist 302 may include identifiers/names of all interior vehicle components that should be inspected by the user 104.

In addition to outputting the first checklist 302, the processor 242 may start to output notifications sequentially, requesting the user 104 to inspect each interior vehicle component in a pre-set order/sequence. For example, the processor 242 may first output a notification requesting the user 104 to inspect the wipers 108, then output another notification requesting the user 104 to inspect fuse/breakers, then output another notification requesting the user 104 to inspect the horn and so on. In some aspects, the processor 242 may output the notifications via the user device 202, the interior vehicle speaker and/or the infotainment system 238.

The notifications output by the processor 242 may be audible and/or visual notifications. In some aspects, the notifications may include information associated with the states of the interior vehicle components, which may be obtained from the vehicle sensory system 232/VCU 210. The processor 242 may output such information associated with one or more interior vehicle components as the notifications associated with the interior vehicle components may be getting outputted. For example, the processor 242 may output the information associated with a state of the fuel gauge as the notification requesting the user 104 to inspect the fuel gauge may be getting outputted. As another example, the processor 242 may output images of sitting area straps and/or other interior vehicle components (captured via vehicle cameras), so that the user 104 may judge the state, condition, wear and tear, cracks, etc. associated with the interior vehicle components.

In further aspects, in addition or alternative to outputting the information associated with the states of the interior vehicle components as described above, the processor 242 may start to automatically activate/actuate one or more interior vehicle components in a sequential manner or in a preset order. For example, the processor 242 may automatically spray the windshield wiper fluid on the windshield and cause the wipers 108 to clean the fluid (e.g., by transmitting a command signal to the BCM 220) when the notification associated with the wiper inspection may be getting outputted.

In further aspects, in addition to outputting the notifications, the information as described above and/or actuating one or more interior vehicle components, the processor 242 may output the component information, e.g., training information, photographs, and/or detailed description associated with the interior vehicle component whose notification may be getting outputted. For example, when the notification requesting the user 104 to inspect the wipers 108 may be getting outputted, the processor 242 may output training information educating the user 104 on how to inspect the wipers 108, photograph(s) associated with the vehicle location where the wipers 108 are located, detailed description of optimal wiper functioning, and/or the like. In some aspects, the processor 242 may first fetch the component information from the memory 244 and then output the information as described above.

The notifications that are output in a sequential manner include requests for the user 104 to inspect the interior vehicle components and provide responses on the first checklist 302 indicating whether the state/condition/status of each interior vehicle component is acceptable or unacceptable to the user 104. In an exemplary aspect, the first checklist 302 may include provisions/means 304 on which the user 104 may provide inputs/responses on whether the state of each interior vehicle component is acceptable or unacceptable to the user 104.

The user 104 may view/hear the notifications as they may be getting outputted on the user device 202, the infotainment system 238, and/or via the interior vehicle speaker and view/hear the different types of information described above and/or the activated/actuated states associated with the interior vehicle components and may provide responses for each interior vehicle component based on the information and/or the activated/actuated states. For example, if the wipers 108 are not cleaning the windshield properly, the user 104 may provide a response on the first checklist 302 indicating that the wiper's condition is unacceptable. On the other hand, if the wipers 108 are cleaning the windshield properly, the user 104 may provide a response on the first checklist 302 indicating that the wiper's condition is acceptable. Similarly, the user 104 may provide responses for other interior vehicle components on the first checklist 302, indicating whether their state/condition is acceptable or unacceptable to the user 104.

The processor 242 may obtain the responses associated with the interior vehicle component states sequentially from the user device 202, the infotainment system 238, one or more vehicle microphones (obtained via user's voice commands), and/or the like via the first checklist 302, as the user 104 inputs the responses on the first checklist 302. As the processor 242 may be obtaining the responses sequentially from the user 104, the processor 242 may check/determine whether any response from the user 104 indicates an unacceptable condition/state of an interior vehicle component.

Responsive to determining that there is a response in the first checklist 302 that indicates an unacceptable condition/state of an interior vehicle component, the processor 242 may either automatically transmit, via the transceiver 240, an error notification to a user/operator/computing device or the server 204 associated with the fleet manager or the vehicle maintenance firm, or output a link on the user device 202/infotainment system 238 through which the user 104 may transmit the error notification to the computing device/server 204. In some aspects, the error notification may include an identifier/name/details associated with the interior vehicle component whose condition is considered as unacceptable by the user 104. The fleet manager/vehicle maintenance firm may analyze the error notification and may accordingly repair/replace the faulty/unacceptable interior vehicle component. In some aspects, the processor 242 may additionally transmit, via the transceiver 240, all the user responses obtained via the first checklist 302 to the server 204 for storage or record-keeping purpose.

The processor 242 may consider the vehicle's interior inspection as complete when responses associated with states of all the interior vehicle components may be obtained from the user 104 (e.g., via the first checklist 302), and no response indicates an unacceptable state of any interior vehicle component. Stated another way, the processor 242 may consider the vehicle's interior inspection as incomplete when one or more responses associated with states of one or more interior vehicle components may be missing or not obtained from the user 104, or one or more responses indicate an unacceptable or suboptimal vehicle component condition/state.

Although the description above describes an aspect where the processor 242 facilitates the user 104 to perform vehicle's interior inspection (or inspection of interior vehicle components) when the user 104 may be located in the vehicle interior portion, the present disclosure is not limited to such an aspect. In some aspects, when the processor 242 determines that the user 104 may be located outside the vehicle 102 in proximity to the vehicle exterior portion (as shown in FIG. 4) based on the inputs obtained from the vehicle sensory system 232, the processor 242 may output a second checklist 402 (by fetching it from the memory 244) via the user device 202, one or more vehicle exterior speakers, sound exciters, and/or the like. The second checklist 402 may be similar to the first checklist 302 and may include identifiers/names associated with the plurality of exterior vehicle components that should be inspected by the user 104 as part of the vehicle inspection process.

In addition to outputting the second checklist 402, the processor 242 may start to output notifications sequentially requesting the user 104 to inspect the exterior vehicle components, the information associated the states of the exterior vehicle components, the component information, and/or the like, in a similar manner as described above for the inspection of the interior vehicle components. Further, as described above, the processor 242 may additionally activate/actuate one or more exterior vehicle components in a sequential manner or in a preset order, as the notifications may be getting outputted.

Responsive to viewing/hearing the notifications, such as the information described above and/or the actuation state of one or more exterior vehicle components, the user 104 may provide responses on the second checklist 402 indicating whether the condition/state of each exterior vehicle component is acceptable or unacceptable to the user 104 in the similar manner as described above. In some aspects, in the case of exterior vehicle inspection, the user 104 may provide responses on the second checklist 402 via the user device 202, voice commands, and/or images associated with the exterior vehicle component that may be captured by the user 104 via a camera (or a camera included in the user device 202).

The processor 242 may obtain the responses from the user 104 via the second checklist 402 in the similar manner as described above and check/determine whether any response from the user 104 indicates an unacceptable condition/state of an exterior vehicle component. Responsive to determining that there is a response in the second checklist 402 that indicates an unacceptable condition/state of an exterior vehicle component, the processor 242 may transmit, via the transceiver 240, the error notification to the user/operator/computing device or the server 204 associated with the fleet manager or the vehicle maintenance firm, as described above.

The processor 242 may consider the vehicle's exterior inspection as complete when responses associated with the states of all the exterior vehicle components may be obtained from the user 104 (e.g., via the second checklist 402), and no response indicates an unacceptable state of any exterior vehicle component. Stated another way, the processor 242 may consider the vehicle's exterior inspection as incomplete when one or more responses associated with the states of one or more exterior vehicle components may be missing or not obtained from the user 104, or one or more responses indicate an unacceptable or suboptimal vehicle component condition/state.

In some aspects, the processor 242 may consider the inspection of the entire vehicle 102 as complete when both the vehicle's exterior inspection and the vehicle's interior inspection may be complete. Stated another way, the processor 242 may consider the inspection of the vehicle 102 as incomplete when either one of the vehicle's exterior inspection or the vehicle's interior inspection is incomplete. Further, if the user 104 performs and completes the vehicle's interior inspection first, the processor 242 may output an alert on the user device 202, the infotainment system 238, and/or the like, requesting the user 104 to move out of the vehicle 102 and complete the vehicle's exterior inspection, thereby completing the inspection of the entire vehicle 102. On the other hand, if the user 104 performs and completes the vehicle's exterior inspection first, the processor 242 may output the alert on the user device 202, the sound exciters, the exterior vehicle speakers, and/or the like, requesting the user 104 to move inside the vehicle 102 and complete the vehicle's interior inspection, to complete the inspection of the entire vehicle 102.

Responsive to determining that both the vehicle's exterior inspection and the vehicle's interior inspection may be complete, the processor 242 may deactivate the vehicle inspection mode, thereby enabling the vehicle 102 to move or shift out of the park mode.

In some aspect, when the user 104 desires to move the vehicle 102 or shift the vehicle 102 out of the park mode, the user 104 may transmit the vehicle movement request or the second request to the transceiver 240 via the user device 202, the infotainment system 238, voice command, vehicle transmission, and/or the like. The processor 242 may obtain the second request from the transceiver 240 and determine/check whether the vehicle inspection (i.e., the inspection of the entire vehicle 102) is complete or not yet complete, or whether the vehicle 102 is in the vehicle inspection mode or not in the vehicle inspection mode responsive to obtaining the second request.

The processor 242 may allow/enable the user 104 to shift the vehicle 102 out of the park mode or drive the vehicle 102 when the processor 242 determines that the vehicle inspection is complete or the vehicle 102 is not in the vehicle inspection mode. On the other hand, the processor 242 may not allow/disable the vehicle 102 from shifting out of the park mode when the processor 242 determines that the vehicle inspection is not yet complete (or is incomplete) or the vehicle 102 is still in the vehicle inspection mode. Stated another way, the processor 242 may disable the vehicle 102 from shifting out of the park mode when the processor 242 determines that at least one response associated with a state of an interior/exterior vehicle component is not obtained from the user 104, or at least one response indicates an unacceptable/suboptimal vehicle component state. In this case, the processor 242 may output a preset message, e.g., “Complete the vehicle inspection before driving the vehicle”, on the user device 202, the infotainment system 238, and/or the like, when the user 104 transmits the second request and the vehicle inspection is not completed. In this manner, the processor 242 encourages the user 104 to complete the vehicle inspection. As described above in conjunction with FIG. 1, the fleet manager may override this vehicle movement disablement feature (e.g., when the fleet manager arranges for replacement or repair of faulty vehicle component(s)).

In further aspects, the vehicle 102 may provide a plurality of additional features to enhance user's convenience of inspecting the vehicle 102 and/or fleet manager's convenience of managing the vehicle 102. For example, the memory 244 may store information associated with maintenance due dates for one or more vehicle components, and the processor 242 may use this information and automatically output/transmit, via the transceiver 240, maintenance reminders to the fleet operator's device or the infotainment system 238 on or before the maintenance due dates. For example, the processor 242 may output a maintenance/replacement reminder one month before an expiry date associated with the fire extinguisher, flashlight batteries, and/or the like. Such reminders may facilitate the fleet manager to optimally maintain the vehicle 102, thereby enhancing vehicle performance.

The vehicle 102 may also provide a provision/feature to the user 104 to contact (e.g., via the user device 202, the infotainment system 238, and/or the like) an expert/technician/mechanic/fleet manager, when the user 104 has any questions on vehicle inspection and/or when the user 104 desires to share real-time vehicle components images to seek expert's opinion.

The vehicle 102 may also share documentation/alerts associated with the vehicle components that are not operating properly with the fleet manager and/or automatically schedule maintenance. In further aspects, the vehicle 102 may enable the fleet manager to set-up and configure/customize (e.g., via the infotainment system 238) the vehicle inspection process as per fleet manager's requirements to ensure that the inspection process aligns with the type of vehicle and the inspection/checks required.

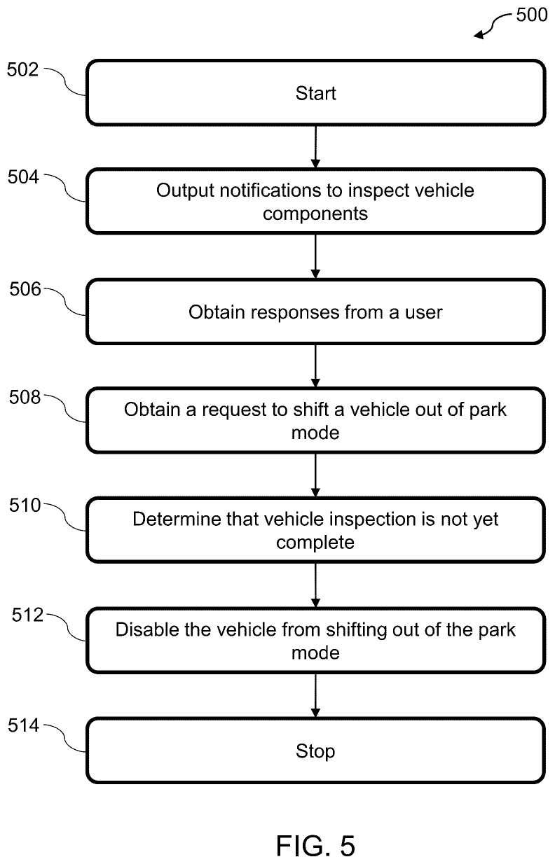

FIG. 5 depicts a flow diagram of a method 500 to facilitate vehicle inspection in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include outputting, by the processor 242, the notifications requesting the user 104 to inspect the vehicle components sequentially, responsive to obtaining the vehicle inspection request or the first request from the user 104. At step 506, the method 500 may include obtaining, by the processor 242, the responses from the user 104 sequentially, responsive to outputting the notifications.

At step 508, the method 500 may include obtaining, by the processor 242, the second request or the vehicle movement request from the user 104 for shifting the vehicle 102 out of the park mode. At step 510, the method 500 may include determining, by the processor 242, that the vehicle inspection is not yet complete, responsive to obtaining the second request or the vehicle movement request from the user 104. At step 512, the method 500 may include disabling, by the processor 242, the vehicle 102 from shifting out of the park mode responsive to determining that the vehicle inspection is not yet complete.

The method 500 may end at step 514.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a processor configured to:
output, responsive to obtaining a first request from a user to perform a vehicle inspection, a plurality of notifications to inspect a plurality of vehicle components, wherein the notifications are output sequentially in a preset order corresponding to one or more checklists for inspecting the plurality of vehicle components; and
obtain, responsive to outputting the plurality of notifications, a plurality of responses associated with states of first vehicle components of the plurality of vehicle components.

2. The vehicle of claim 1, wherein the processor is further configured to:
obtain a second request from the user to shift the vehicle out of a park mode;
determine that the vehicle inspection is not yet complete responsive to obtaining the second request, wherein the vehicle inspection is complete when a response associated with a state of each vehicle component, of the plurality of vehicle components, is obtained from the user; and
disable the vehicle from shifting out of the park mode responsive to determining that the vehicle inspection is not yet complete.

3. The vehicle of claim 1, wherein the processor is further configured to automatically activate at least one vehicle component of the plurality of vehicle components responsive to outputting the plurality of notifications.

4. The vehicle of claim 1, wherein the processor is further configured to:
obtain the first request from the user;
activate a vehicle inspection mode responsive to obtaining the first request; and
output the one or more notifications responsive to activating the vehicle inspection mode.

5. The vehicle of claim 4, wherein the processor is further configured to:
determine that the vehicle inspection is complete; and
deactivate the vehicle inspection mode responsive to determining that the vehicle inspection is complete.

6. The vehicle of claim 1, wherein the plurality of vehicle components comprises at least one of a plurality of interior vehicle components or a plurality of exterior vehicle components.

7. The vehicle of claim 6, further comprising a sensor unit configured to detect a presence of the user in a vehicle interior portion or in proximity to a vehicle exterior portion.

8. The vehicle of claim 7, wherein the processor is further configured to:
determine that the user is located in the vehicle interior portion based on inputs obtained from the sensor unit, responsive to obtaining the first request;
output a first checklist comprising identifiers associated with the plurality of interior vehicle components, responsive to determining that the user is located in the vehicle interior portion;
output a plurality of first notifications to inspect a plurality of first interior vehicle components, responsive to outputting the first checklist; and
obtain a plurality of first responses from the user associated with states of the plurality of first interior vehicle components via the first checklist, responsive to outputting the plurality of first notifications sequentially.

9. The vehicle of claim 8, wherein the processor outputs the first checklist via a user device, a vehicle Human-Machine Interface (HMI), or a vehicle interior speaker.

10. The vehicle of claim 7, wherein the processor is further configured to:
determine that the user is located in proximity to the vehicle exterior portion based on inputs obtained from the sensor unit, responsive to obtaining the first request;
output a second checklist comprising identifiers associated with the plurality of exterior vehicle components, responsive to determining that the user is located in proximity to the vehicle exterior portion;
output a plurality of second notifications to inspect a plurality of second exterior vehicle components responsive to outputting the second checklist; and
obtain a plurality of second responses from the user associated with states of the plurality of second exterior vehicle components via the second checklist, responsive to outputting the plurality of second notifications sequentially.

11. The vehicle of claim 8, wherein the sensor unit is further configured to determine information associated with a state of a vehicle component, wherein the information associated with the state comprises at least one of an information associated with a change in state of the vehicle component over a predefined time duration or a vehicle component image, and wherein the processor is further configured to output the information associated with the state.

12. The vehicle of claim 1, wherein the processor is further configured to:
determine that at least one response of the plurality of responses indicates an unacceptable state of a vehicle component of the plurality of vehicle components; and
transmit an error notification to a user device or a server responsive to determining that the at least one response indicates the unacceptable state of the vehicle component.

13. The vehicle of claim 12, wherein the processor is further configured to disable the vehicle when the processor determines that the at least one response indicates the unacceptable state of the vehicle component.

14. The vehicle of claim 1, wherein the vehicle inspection is complete when all of the plurality of responses obtained from the user indicate acceptable states of all of the plurality of vehicle components.

15. The vehicle of claim 1, further comprising a memory configured to store a component information associated with each vehicle component of the plurality of vehicle components, wherein the processor is further configured to:
fetch the component information from the memory; and
output the component information sequentially for each vehicle component, when a notification associated with each vehicle component is outputted.

16. The vehicle of claim 15, wherein the component information comprises at least one of a training information, photographs or detailed description associated with each vehicle component.

17. The vehicle of claim 15, wherein the memory is further configured to store an information associated with a maintenance due date for at least one vehicle component of the plurality of vehicle components, and wherein the processor is further configured to output a maintenance reminder on the maintenance due date based on the information associated with the maintenance due date.

18. The vehicle of claim 2, wherein the processor obtains one or more of the first request, the second request, and the plurality of responses via at least one of a user device, a vehicle Human-Machine Interface (HMI), a camera, or a voice command, and wherein the processor is further configured to transmit the plurality of responses to an operator device or a server.

19. A method to facilitate inspection of a vehicle, the method comprising:
outputting, by a processor, a plurality of notifications to inspect a plurality of vehicle components, responsive to obtaining a request to perform a vehicle inspection, wherein the notifications are output sequentially in a preset order corresponding to one or more checklists for inspecting the plurality of vehicle components; and
obtaining, by the processor, a plurality of responses associated with states of vehicle components of the plurality of vehicle components, responsive to outputting the plurality of notifications.

20. A non-transitory computer-readable storage medium having instructions stored thereupon which, when executed by a processor, cause the processor to:
output a plurality of notifications to inspect a plurality of vehicle components, responsive to obtaining a request to perform a vehicle inspection, wherein the notifications are output sequentially in a preset order corresponding to one or more checklists for inspecting the plurality of vehicle components; and
obtain a plurality of responses associated with states of vehicle components of the plurality of vehicle components, responsive to outputting the plurality of notifications.
